(19) United States
(12) Patent Application Publication
(10) Pub. No.: US 2022/0065278 A1
(43) Pub. Date: Mar. 3, 2022

(54) FASTENING DEVICE AND METHODS OF MANUFACTURE

(71) Applicant: Raymond Chiman Young, MARKHAM (CA)

(72) Inventor: Raymond Chiman Young, MARKHAM (CA)

(21) Appl. No.: 17/008,909

(22) Filed: Sep. 1, 2020

(51) Int. Cl. F16B 15/06; B21G 3/20

(52) U.S. Cl. CPC F16B 15/06; B21G 3/20

(57) ABSTRACT

Embodiments described herein provide a fastening device such as a nail or staple having at least one projection each extending away from the body at an angle and away from a tip of the body. For example, in the case of a nail, there can be two or more projections extending from the elongated member of the nail each at a substantially equal distance from the head and/or along the length of the elongated member each spaced at substantially equal distances apart. In the case of a staple, there can be at least one projection connected to the interior surface of a first leg of the staple, that surface being substantially opposite to an interior surface of a second leg of the staple. The tip can be sharp or not sharp. The projections can be connected to exterior surfaces of the staple's legs.

### FIELD

The present disclosure generally relates to the field of fastening devices, and, in particular, to fastening devices such as nails and staples and methods of manufacturing same.

### INTRODUCTION

Construction workers, carpenters and other people use fasteners, such as nails and staples, to perform various jobs or tasks with materials. Materials such as wood can shrink over time and can be exposed to strong winds.

### SUMMARY

In accordance with an aspect, there is provided a fastening device, having a substantially straight body having at least one projection each extending from the body at an upward angle.

In accordance with an aspect, there is provided a fastening device including a substantially straight elongated member, the elongated member extending from a head to a tapered tip along a longitudinal axis and having at least one projection each extending from the elongated member at an upward angle away from the tip.

The fastening device of claim 1, the elongated member having two projections, each projection being on substantially opposite sides of the surface of the elongated member.

In some embodiments, the distance measured between a first projection tip of a first projection and a second projection tip of a second projection is a length that is up to the length of the head measured along a substantially identical axis.

In some embodiments, the width of the elongated member and the distance that one or more of the projections extend from the elongated member measured along substantially the same axis, is double the width of the elongated member measured along substantially the same axis.

In some embodiments, the body is an elongated member extending from a head to a tip along a longitudinal axis, the body having two or more projections connected to the elongated member.

In some embodiments, there is at least one projection connected to the elongated member and extending at an angle away from the tip.

In some embodiments, the angle is in a range from about 60 degrees to about 88 degrees.

In some embodiments, two or more projections extend from the elongated member each at a substantially equal distance from the head.

In some embodiments, two or more projections are connected to the elongated member along an axis substantially orthogonal to the longitudinal axis, the two or more projections being spaced apart at substantially equal distances on the surface of the elongated member.

In some embodiments, there is at least one projection connected to the elongated member at a distance from the head equal to about 15% of the length of the elongated member measured from the head to the tip.

In some embodiments, there are two or more projections being spaced apart at substantially equal distances on the surface of the elongated member along the longitudinal axis.

In some embodiments, there is at least one projection connected to the elongated member at a distance from the tip equal to about 7.5% of the length of the elongated member measured from the head to the tip.

In some embodiments, the tip is not sharp.

In some embodiments, the tip is sharp.

In some embodiments, the head is about equal to or larger than the elongated member.

In accordance with an aspect, there is provided a fastening device, having a first leg; a second leg being substantially parallel to the first leg and connected to the first leg at a joining member arranged substantially orthogonal to the first leg and the second leg; and at least one projection connected to the first leg and extending from the first leg at an angle. The fastening device can be a staple, for example.

In some embodiments, at least one projection is connected to an interior surface of the first leg, the interior surface being substantially opposite to an interior surface of the second leg. In some embodiments, one or more projections can also be on the exterior walls of the leg or legs if applicable.

In some embodiments, there is at least one projection connected to the first leg and extending upwardly at an angle away from a tip of the first leg.

In some embodiments, the angle is in a range from about 60 degrees to about 88 degrees. This can be an upward angle, for example.

In some embodiments, one or more projections are spaced apart at substantially equal distances on the interior surface of the first leg along the longitudinal axis, and one or more projections are spaced apart at substantially equal distances on the interior surface of the second leg along the longitudinal axis.

In some embodiments, the tip is not sharp.

In some embodiments, the tip is sharp.

In accordance with an aspect, there is provided a method for forming a fastening device, the method including forming a body with at least one projection connected to the body and extending at an angle away from a tip of the body by applying material to a cavity in a mold and removing the material from the mold.

In some embodiments, the material is metal and the method further includes, after removing the material from the mold, shaping the metal to form the body with the at least one projection connected to the body and extending at the angle away from the top of the body.

In accordance with an aspect, there is provided a method for forming a staple, the method including forming a wire having at least one projection extending at an angle from the wire by applying material to a cavity in a mold; removing at least one piece of material from the mold, the at least one piece of material being the wire; and shaping the wire to form a fastening device having a first leg; a second leg being substantially parallel to the first leg and connected to the first leg at a joining member arranged substantially orthogonal to the first leg and the second leg; and at least one projection connected to the first leg and extending from the first leg at an angle.

In accordance with an aspect, there is provided a fastening device, comprising a substantially straight body having at least one projection each extending from the body at an angle.

Other aspects and features and combinations thereof concerning embodiments described herein will be become apparent to those ordinarily skilled in the art upon review of the instant disclosure of embodiments in conjunction with the accompanying figures.

### DESCRIPTION OF THE DRAWINGS

In the figures, embodiments are illustrated by way of example. It is to be expressly understood that the description and figures are only for the purpose of illustration and as an aid to understanding. Embodiments will now be described, by way of example only, with reference to the attached figures, wherein in the figures:

FIG. 1 is a perspective view of a front view of a nail, according to some embodiments;

FIG. 2 is a perspective view of a front view of a nail, according to some embodiments;

FIG. 3 is a perspective view of a staple, according to some embodiments; and

FIG. 4 is a perspective view of a staple, according to some embodiments.

### DETAILED DESCRIPTION

Embodiments described herein provide a fastening device such as a nail or staple having projections along one or more shafts or legs. At least a portion of each projection can extend upwardly from the shaft or leg in a direction substantially opposite from a tip of the shaft or leg and help prevent backward removal of the fastening device in some embodiments. For example, the projections of the fastening device can improve and better secure the fastening of material such as wood during strong winds or when the material shrinks or dries and the fastening device or wood would otherwise be loosened or the fastening effect would otherwise be diminished. This can improve the fastening device's anchoring or holding power on wood construction including flooring, roofing, framing, and decking. The fastening device can help prevent material such as wood from splitting when the fastening device is applied to it. This may be accomplished when the projections are driven into the material (e.g., upon sudden force from wind or gradual loosening of the fastening device in the material over time) to provide resistance to movement according to some embodiments. In some embodiments, this can provide an advantage over straight or smooth nails that do not have the projections. Fastening devices described herein can provide an increased fastening or holding strength on the wood structures or other items, whether inside or outside for a longer period of time.

Various embodiments of a fastening device having a substantially straight body and at least one projection each extending from the body at an angle will now be described. At least a portion of a projection can point away from the tip of the body. The projection can extend a distance from the body that allows or facilitates a fastening effect of the fastening device or that facilitates lodging or driving the projection into a material to which the fastening device is applied.

As an example, the size relationship between a nail's head and its body or shank can be between about 2.1 to 2.3 times, inclusive. In other words, the head for many nails is at least 2 times the shank, according to some embodiments. According to some embodiments described herein, projections such as barbs or anchors are added to the shank such that the total shank diameter including the projections can be up to double the original size. In some embodiments, the projections can increase a nail's holding power by at least about 100% as the projections can allow the nail to hold, attach to, or fasten materials better than when having a smooth shank such as without the projections. In some embodiments, the projections can increase a nail's shank or a staple's leg sizes to double, and the resulting shank or leg having the projections can increase the holding power of the nail or staple by about 100% as the barbs can secure the fastening device more strongly to material than a fastening device with just a smooth shank or legs, according to some embodiments. In some embodiments, the projections can be of a dimension or length such that the total shank diameter or width measured to include the projections, can be about: 5%, 10%, 15%, 20%, 25%, 30%, 35%, 40%, 45%, 50%, 55%, 60%, 65%, 70%, 75%, 80%, 85%, 90%, 95%, or 98% greater than the total shank diameter or width measured to not include the projections.

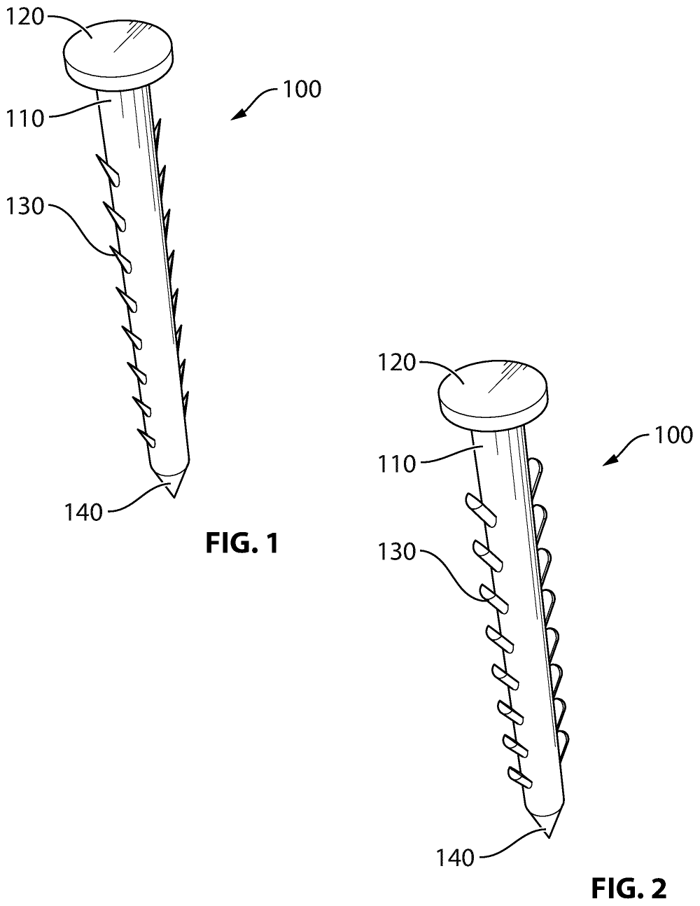

FIGS. 1 and 2 are perspective views of an example nail 100, according to some embodiments. As shown, nail 100 has an elongated member 110 that extends in a longitudinal direction (along a longitudinal axis) from a head 120 to a tip 140. The elongated member 110 can be a shank, for example. The elongated member 110 has projections 130 along a portion of its length from the head 120 to the tip 140 along the longitudinal axis and extending in a direction substantially towards the head 120. The projections 130 are connected to the elongated member 110 at one or more locations along the elongated member 110. The tip 140 can be sharp or not sharp, such as blunted, rounded, or smooth, for example. In some embodiments, the tip is not sharp. For example, the tip can be tapered and end in a flat edge. In some embodiments, the tip is sharp. For example, the tip can be tapered and end in a point. A sharp tip 140 may be not incorporated in some embodiments as that can split the wood or other material that the nail 100 can be applied to in some applications. For example, a smooth tip 140 can help prevent the wood or other material from splitting when the nail is applied by hammer or an air gun.

The tip of a projection 130 can be smooth or sharp. A smooth tip can enhance a holding strength of the fastening device and/or facilitate holding of the fastening device without hurting one's fingers, in some embodiments. The tip of a projection 130 can be sharp or smooth and selected as such based on the size, application, and/or desired fastening effect of the nail 100. The tip of a projection 130 can refer to an end of the projection 130 that is not directly adjoining or abutting the elongated member 110.

FIG. 1 shows an example nail 100 having projections 130 with sharp tips, according to some embodiments. FIG. 2 shows an example nail 100 having projections 130 with smooth tips, according to some embodiments.

The projections 130 can be anchors, barbs, extensions, hooks (e.g., similar to fish hooks), spikes, protrusions, spurs, thorns, needles, prickles, spines, quills, bristles, tines, or a combination of same, for example. The projections 130 can be arranged along the elongated member 110 in a variety of configurations. For example, in some embodiments, the projection 130 is designed to be in a straight shape, but can be in a curved shape for particular usages or where such a shape is required or warranted. The shape, quantity, angle, size, shape, and tip configuration can be different in different embodiments and can be configured based on the size or application of the nail 100.

In some embodiments, there is only one projection 130 on only one side of the elongated member 110. In some embodiments, there are at least two projections 130 aligned on the elongated member 110. For example, one projection 130 can be positioned on one portion of the surface of the elongated member 110, while a second projection 130 can be positioned on a substantially opposite side of that portion of the surface of the elongated member 110 (e.g., opposite being in a direction transverse to the longitudinal axis of the elongated member 110), with both projections 130 at a substantially equal distance from the head 120 (e.g., along the longitudinal axis). As another example, one projection 130 can be positioned on one portion of the surface of the elongated member 110, while a second projection 130 can be positioned on a substantially opposite side of that portion of the surface of the elongated member 110 (e.g., opposite being in a direction transverse to the longitudinal axis of the elongated member 110), where the projections 130 are along the elongated member 110 at a different distance from the head 120 in the longitudinal direction. In some embodiments, the elongated member 110 has two or more anchoring hooks 130, with the number depending on the size and length of the elongated member 110. Multiple projections 130 (e.g., more than two) can be so configured and positioned along the surface of the elongated member 110.

In some embodiments, two or more projections are positioned along an axis substantially transverse to the longitudinal axis and are spaced apart along that transverse axis at substantially equal distances on the surface of the elongated member. For example, a set of projections 130 can include one or more projections 130 at a substantially equal distance from the head 120 in the longitudinal direction. Each projection 130 can extend from a different side of the elongated member 110 or multiple projections 130 can extend from different sides of the elongated member 110. For example, in a set, there may be two projections 130 arranged on the surface of the elongated member 110 on substantially opposite sides of the surface of the elongated member 110 (e.g., opposite in the transverse direction). As another example, in a set, there may be three or more projections 130 arranged at substantially equal distances apart around the body of the elongated member 110 (e.g., along the same transverse axis of the elongated member 110). In some embodiments, projections 130 at a substantially equal distance from the head 120 are arranged at differing distances apart from each other around the body of the elongated member 110 (e.g., along an axis orthogonal to the longitudinal axis of the elongated member 110). In some embodiments, multiple projections 130 can extend from a first side of the elongated member 110 and multiple projections 130 can extend from a second or multiple other sides of the elongated member 110. In some embodiments, the distance(s) apart that the projections 130 are around the elongated member 110 (e.g., around the circumference of the elongated member) can be fixed or designed based on the size and/or application of the nail 100.

In some embodiments, two or more sets of projections 130 are arranged along the length of the elongated member 110 from the head 120 to the tip 140. In some embodiments, three or more sets of projections 130 are arranged at substantially equally spaced distances along the length of the elongated member 110 from the head 120 to the tip 140. For example, the distance can be about 7.5% of the length of the elongated member 110. This can be 0.25 inches for an appropriately sized nail 100. In some embodiments, three or more sets of projections 130 are arranged along the length of the elongated member 110 from the head 120 to the tip 140, with at least one set at a different distance from a neighbouring set as compared to the distance between another set to its own neighbouring set.

In some embodiments, projections 130 can be spaced apart along the elongated member 110 in the longitudinal direction. In some embodiments, projections 130 are spaced apart along the elongated member 110 along the longitudinal axis at substantially equal distances. The projections 130 can be spaced apart at a distance that is about 7.5% of the total length of the elongated member 110. For example, this can be about 0.25 inches. The projections 130, for example, as barbs, can be spaced apart at a distance that is about 3.75% of the total length of the elongated member 110. For example, this can be about ⅛ inches apart. In some embodiments, projections 130 are spaced apart along the elongated member 110 along the longitudinal axis at different distances. In some embodiments, the distances apart of each set of projections along the length of the elongated member 110 can be subject to the size and/or usage of the nail 100. For example, 7.5% of the total length of the elongated member 110 can be a reasonable distance apart for projections 130 arranged along the length of the elongated member 110.

In some embodiments, the projections 130 are arranged along a portion of the elongated member 110 along the longitudinal axis from a distance spaced from the head 120 to a distance spaced from the tip 140. The distance from the head 120 and the first projection(s) 130 along the longitudinal axis can be about 15% of the total length of the elongated member 110 measured along the longitudinal axis. For example, the distance can be 0.5 inches. The distance from the tip 140 and the closest projection(s) 130 along the longitudinal axis can be about 7.5% of the total length of the elongated member 110 measured in the longitudinal direction or about half the distance from the head 120 and the first or closest projection(s) 130 to the head 120 along the longitudinal axis. For example, the distance can be about 0.25 inches. As an example, a nail 100 can be 3 inches long, gauge 9, with an elongated member 110 diameter slightly smaller than the head 120 and having projections 130 (e.g., anchors, barbs) along the length of the elongated member 110 along the longitudinal axis from about 0.5 inches (or 15% of the total elongated member length) below the head 120 to about 0.25 inches from the tip 140. Each anchor of the elongated member 110 can be spaced about 0.25 inches apart along the longitudinal axis of the elongated member 110. In various embodiments, the quantity and/or distance of the projections 130 along the elongated member 110 can be based on the nail's 100 size and application.

In some embodiments, the projections 130 extend from the elongated member 110 with at least a portion of the projection at an angle relative to the elongated member 110. For example, the projections 130 can extend towards the head 120 at an angle relative to the elongated member 110 that is about equal to or less than 90 degrees or equal to about 60 degrees. As another example, the angle can be an angle in the range of about 60 degrees to about 88 degrees. As other examples, the angle can be about 65 degrees, about 70 degrees, about 75 degrees, or about 80 degrees. The angle can be selected based on the size or dimensions of the nail 100, its usage or application, and/or a desired fastening strength. As an example, if the projection 130 is a hook, the projection 130 can extend from the elongated member 110 initially substantially towards the tip 140 and subsequently substantially towards the head 120 at the angle relative to the elongated member 110. As another example, at least one projection 130 can be connected to the elongated member 110 and extend at an angle away from the tip 140, whether near the portion that is connected to the elongated member 110 or at another portion such as at an end of the projection 130 that is not connected to the elongated member 110. As another example, the projections 130 can extend upwards in a direction substantially towards the head 120. As another example, the projections 130 can extend in a direction substantially opposite to the tip 140. In some embodiments, the projections 130 provide an improved fastening effect by holding the material that the nail 100 is applied to together. For example, the projections 130 can help prevent the nail 100 from becoming dislodged during strong winds or when the material it is applied to shrinks and the nail 100 would be otherwise loosened or its fastening effect otherwise diminished. This can be an improvement over nails without one or more projections 130.

In some embodiments, a projection 130 extends from the elongated member 110 at a distance that can allow the projection 130 to adequately lodge into the material to which the nail 100 is applied, for example, to impede movement of the nail 100 such as during strong winds or expansion of the channel in which the nail 100 is positioned in the material. This can help secure the nail 100 in the channel, improve the stability of the connection between the nail 100 and the material, and improve, maintain, or facilitate a fastening effect of the nail 100 to the material, in some embodiments.

In some embodiments, nail 100, including at one or more projections 130, can facilitate a threshold level of fastening effect or security of the nail 100 in material to which the nail 100 is applied. For example, the fastening effect can secure pieces of material such as wood together at a location where the nail 100 is applied to the material. This level of fastening may be greater than, equal to, or less than the strength of a fastening effect of the nail 100 before the nail 100 is loosened or strained, such as by strong winds, forces applied to the nail 100 or material to which it is applied, backward or other directional forces applied to the nail 100, shrinkage of the material to which the nail 100 is applied, forces that tend to dislodge or loosen the nail 100, or other disturbance, whether over time or on sudden occasion.

In some embodiments, the head 120 is larger than the elongated member, for example, about 2.1 to about 2.3 times larger than the elongated member 110. For example, in the case of a head 120 and elongated member 110 both with circular cross sections, the circumference of the head 120 can be about 2.1 to about 2.3 times larger than the circumference of the elongated member 110. In some embodiments, the head 120 of the nail 100 is sized and dimensioned to be at least as large as an anticipated amount of shrinkage of the material to which it is applied at the location surrounding its elongated member 110. This can allow the nail 100 to maintain or sustain a threshold level of fastening even when the material shrinks or when the nail 100 is loosened. The nail 100 can be maintained in the material, for example, to secure pieces of material together, rather than dislodged when the head 120 is sized and dimensioned as such. In some embodiments, the head 120 is only slightly larger than the elongated member. In some embodiments, the head 120 is only slightly larger than the elongated member 110, the elongated member 110 measured to include projection(s) 130.

In some embodiments, the projections 130 are sized and dimensioned no larger than the head 120 of the nail 100. For example, the projections 130 may not extend a distance away from the elongated member 110 beyond the distance that the head 120 extends away from the elongated member 110 along the same axis or in the same direction. For example, a combined diameter or width of the total projection 130-elongated member 110 assembly may be slightly less than that of the head 120. In some embodiments, the projections 130 extend a distance away from the elongated member 110 that allows, facilitates, enables, maintains, sustains, and/or improves a fastening effect of the nail 100 (e.g., as compared to a nail without projections 130) and/or facilitates driving projections 130 into the material to which the nail 100 is applied such as to resist movement, force, or loosening. For example, the fastening effect may be greater than or equal to or above a threshold level of a fastening effect otherwise achievable by the nail 100 without any projections 130.

As an example, the projections 130 can extend from the elongated member 110 such that the distance of the extensions is equal to the width or diameter of the elongated member 110, doubling the combined diameter or width of the total projection 130-elongated member 110 assembly. For example, if a projection 130 extends at an angle from the elongated member 110 and a second projection 130 extends at an angle from the elongated member 110 on the opposite side of the elongated member 110 (opposite being on the opposite side of a longitudinal axis extending from the head 120 to the tip 140 of the nail 100), the total length measured from the portion of the first projection 130 that is farthest from the elongated member 110 to the portion of the second projection 130 that is farthest from the elongated member 110 is about double the width of the elongated member 110 measured along the same axis. As an example, if the elongated member 110's diameter is 0.148 inches, the total diameter of the projection 130-elongated member 110 assembly can be 0.29 inches. For example, the projections 130 can extend a distance from the elongated member 110 to double the diameter of the shank measured to include the projections 130. In some embodiments, the combined length or diameter of the projection 130-elongated member 110 unit is slightly less than that of the head 120, for example, as measured along a substantially parallel axis.

In some embodiments, the projections 130 each extend a distance away from the elongated member 110 such that the combined diameter or width of the total projection 130-elongated member 110 assembly is about: 5%, 10%, 15%, 20%, 25%, 30%, 35%, 40%, 45%, 50%, 55%, 60%, 65%, 70%, 75%, 80%, 85%, 90%, 95%, or 98% greater than the elongated member 110 diameter or width measured to not include the projections and measured along substantially the same axis.

In some embodiments, the nail 100 includes a substantially straight elongated member, the elongated member extending from a head to a tapered tip along a longitudinal axis and having at least one projection each extending from the elongated member at an upward angle away from the tip. In some embodiments, the elongated member has two or more projections. In some embodiments, the distance measured between a first projection tip of a first projection 130 and a second projection tip of a second projection 130 is a length that is up to the length of the head 120 measured along a substantially identical axis. For example, the projections 130 along an axis substantially parallel to an axis defined by the head 120 can extend away from the elongated member 110 such that the farthest points away from the elongated member 110 of projections 130 comprise a distance that is double the width of the elongated member 110 measured along substantially the same axis. The distance can also be up to the width of the head 120 measured along substantially the same axis.

For example, in some embodiments, the width of the elongated member 110 and the distance that one or more of the projections 130 extend from the elongated member 110 measured along substantially the same axis, is double the width of the elongated member 110 measured along substantially the same axis.

Example lengths of a projection 130 include about 0.07 inches for an about 3 inch long nail 100 with a head 120 having about a 5/16 inch diameter, about 2% of the length of a nail 100, or about 20% of the length or diameter of the head 120 of a nail 100. An example configuration of a nail 100 includes the projection 130 nearest to the head 120 positioned at about 0.5 inches below the head 120, with each projection 130 about ⅛ inches apart from the nearest projection 130, and the combined diameter or length measured from the farthest extensions of the projections 130 (along an axis substantially orthogonal to the longitudinal axis or substantially parallel to an axis defined by the head 120) being about slightly less than that of the head 120 (measured along an axis substantially parallel to the same orthogonal axis).

In some embodiments, the length of a projection 130 can be equal to the length of another projection 130. In some embodiments, the length of a projection 130 is different from the length of another projection 130. For example, the projections 130 can have different lengths.

The following table describes example sizes and configurations of the head 120 and elongated member 110 according to some embodiments. The head 120 and elongated member 110 can be sized and dimensioned to be about the following indications where the nail 100 is used for woodwork or construction applications, for example. As shown, the head 120 can be double the size of the elongated member 110.

TABLE 1
Example Dimensions for a Nail.

| | | | | | Ratio of |
|---|---|---|---|---|---|
| | | Elongated | Elongated | | Diameter |
| | | Member | Member | Head | of Head to |
| | | Diameter | Length | Diameter | Elongated |
| Nail Size | Gauge | (inches) | (inches) | (inches) | Member |
| 2D | 15 | 0.072 | 1 | 3/16 | 2.6 |
| | | (0.183 cm) | (2.54 cm) | (0.476 cm) | |
| 3D | 14 | 0.083 | 1.25 | 13/64 | 2.44 |
| | | (0.211 cm) | (3.175 cm) | (0.516 cm) | |
| 4D | 12 | 0.109 | 1.5 | ¼ | 2.29 |
| | | (0.277 cm) | (3.81 cm) | (0.635 cm) | |
| 10D | 9 | 0.148 | 3 | 5/16 | 2.11 |
| | | (0.376 cm) | (7.62 cm) | (0.794 cm) | |
| 12D | 9 | 0.148 | 3.25 | 5/16 | 2.11 |
| | | (0.376 cm) | (8.26 cm) | (0.794 cm) | |
| 16D | 8 | 0.165 | 3.5 | 11/32 | 2.06 |
| | | (0.419 cm) | (8.89 cm) | (0.864 cm) | |

For example, nail 100 can be size 10D, gauge 9, and 3 inches long, with an elongated member 110 diameter of 0.148 inches, a head 120 diameter of 5/16 inches, where the diameter is the standard size of a nail. By including the barbs 130, its diameter can be double. A projection 130 such as a barb can be about ⅛ inches apart, with each projection 130 being about 0.07 inches long or extending about 0.07 inches away from the elongated member 110.

The nail 100 can be made out of a variety of materials including metal, non-metal, a strong material, a hardening material, a combination of metal and non-metal material, or a combination of same. The composition of the material or metal used can be varied and can be selected for the particular application of the nail 100.

The head 120 and elongated member 110 can be circular, elliptical, annular, square, polygonal, or otherwise shaped.

The nail 100 can be applied to a material using a hammer or air gun and can be used on materials such as wood, asphalt, PVC, or metal, for applications such as roofing (including constructing a roof with shingles), flooring, wall framing, joints, siding or tightening pieces of material. The nail 100 can be a pneumatic nail, bulk nail, framing nail, or nail configured for use with various applicators such as nail guns or pneumatic nail guns, for example. On application of the nail 100 to the material, the nail 100 provides a fastening effect, such as the fastening of separate pieces of wood together, in some embodiments.

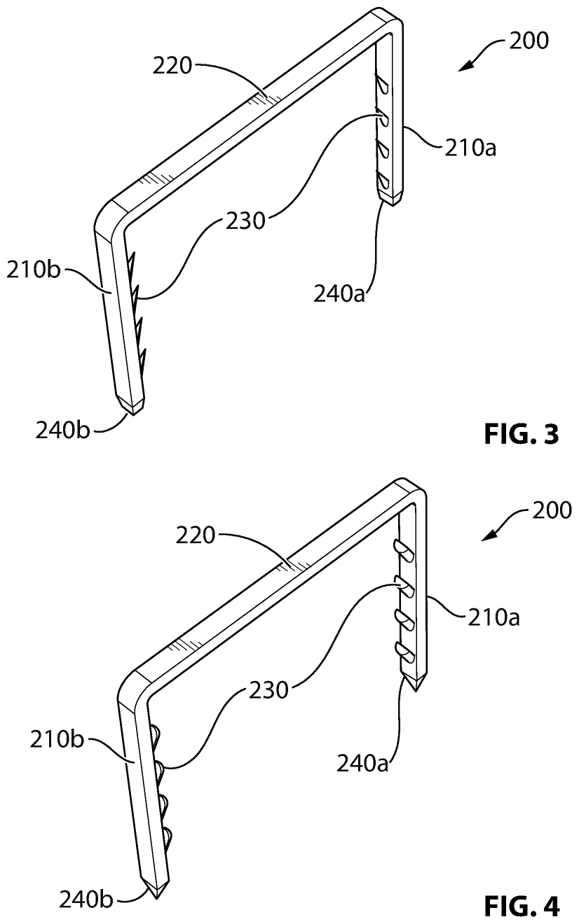

FIGS. 3 and 4 are a perspective view of an example staple 200, according to some embodiments. As shown, staple 200 has two legs 210a and 210b having tips 240a and 240b, respectively, at one end of the respective leg. The tip 240 can be sharp or not sharp, such as blunted, rounded, or smooth, for example. FIG. 3 shows an example staple 200 having not sharp tips 240a and 240b and projections 230 having sharp tips. FIG. 4 shows an example staple 200 having sharp tips 240a and 240b, as well as projections 230 having smooth tips. Each of leg 210a and 210b is joined at the other end to the other leg by joining member 220. The joining member 220 extends substantially perpendicularly from the respective end of each of the legs 210a and 210b. The joining member 220 can be an arch, for example. Each of leg 210a and 210b has one or more projections 230 along the length of the leg. In some embodiments, projections 230 are positioned at spaced intervals along the length of each leg 210a and 210b. The intervals can be selected based on the size and/or use or application of the staple 200 and/or a desired fastening strength. For example, the interval can be about 7.5% of the total length of the respective leg 210a or 210b. The interval distances can be equal along one leg 210a or 210b, equal along both legs 210a and 210b, or unequal along one or both legs 210a and 210b. In some embodiments, there is a distance between the end of a leg 210 that connects to the joining member 220 and the first or nearest projection 230 of that leg 210. This distance may be substantially equal to a corresponding distance at the other leg 210. Similarly, in some embodiments, there is a distance between the end 240 of a leg 210 and the nearest projection 230 of that leg 210. This distance may be substantially equal to a corresponding distance at the other leg 210. The distance can be selected based on the size and/or use or application of the staple 200 and/or a desired fastening strength. The distance of projections 230 along an inside wall of the staple 200 (e.g., an inside surface of a leg 210 such as a surface of the leg 210 that opposes a surface of another leg 210) can be selected based on the size and application of the staple 200.

As an example embodiment, staple 200 can have two legs having the same length and are formed in a substantially upside-down U-shape. The two legs can be substantially parallel to each other. Staple 200 has projections 230 such as barbs that are on the inside surface of each leg and are directed upward. This can allow for a small outside wall of each leg so as to be compatible with some applicator machines. However, barbs or hooks can be applied on a leg's or legs' outside surfaces if required, according to some embodiments.

In some embodiments, at least a portion of one or more projections 230 extends from a leg 210 in a substantially opposite direction from the tip 240 of that leg 210. In some embodiments, one or more projections 230 are positioned substantially on an interior surface of a leg 210, that is, on a surface that opposes an opposing leg 210. In some embodiments, no projections 230 are positioned on any other surface of the leg 210 apart from the interior surface of the leg 210. In some embodiments, one or more projections 230 are positioned at various positions on the leg 210a and 210b, for example, on an exterior surface of the leg 210 or other surface, such as for smaller sized staples or special applications or where an applicator machine is configured to accommodate same. The projections 230 can be spaced apart at substantially equal distances on the surface of each leg along the longitudinal axis. The number of projection(s) 230 that are connected to each of the legs 210a or 210b can be configured depending on the size and/or length of each respective leg 210a or 210b.

The tip of a projection 230 can be smooth or sharp. A smooth tip can enhance a holding strength of the fastening device and/or facilitate holding of the fastening device without hurting one's fingers and/or reduce the splitting of wood or other material the staple 200 is applied to, in some embodiments. The tip of a projection 230 can be sharp or smooth and selected as such based on the size, application, and/or desired fastening effect of the staple 200. The tip of a projection 230 can refer to an end of the projection 230 that is not directly adjoining or abutting a leg 210.

In some embodiments, staple 200 includes more than two legs 210 with one or more of the legs 210 having one or more projections 230. The one or more projections 230 facilitate a fastening effect of the staple 200 applied to material, for example, to join or secure multiple pieces of material together.

In different embodiments, the number, size, positioning, angle, shape, materials, distances, spacing, configurations relative to different components of the staple 200, and other configurations of any portion of the staple 200 are as described in relation to the nail 100 in various different embodiments. The shape, quantity, angle, size, shape, and tip configuration of the projections 230 can be different in different embodiments and can be configured based on the size or application of the staple 200. In various embodiments, the quantity and/or distance of the projections 230 along a leg 210 can be based on the staple 200's size and application.

In some embodiments, the staple 200 has at least one projection connected to a leg 210 and extending at an angle away from the tip 240 of that leg 210. For example, the angle and length of one or more projections 230 relative to the corresponding leg 210 can be as described for the one or more projections 130 relative to the elongated member 110. The angle of one or more projections 230 relative to a leg 210 that they are connected to can be about 60 degrees and extending toward the joining member 220. The angle can be measured near the portion of the projection 230 that connects to the leg 210 or can be measured at a different portion such as near the other end of the projection 230. As an example, the angle can be an angle from the range of about 60 degrees to about 88 degrees. For example, the angle can be about 65 degrees, 70 degrees, about 75 degrees, about 80 degrees, about 85 degrees, or any angle in between. In some embodiments, projections 230 extend a distance away from each of one or more legs 210 that allows, facilitates, enables, maintains, sustains, and/or improves a fastening effect of the staple 200 and/or facilitates driving projections 230 into the material to which the staple 200 is applied such as to resist movement, force, or loosening. For example, the fastening effect may be greater than or equal to, a fastening effect otherwise achievable by the nail 200 without any projections 230. The projections 230 can be anchors, barbs, extensions, hooks (e.g., similar to fish hooks), spikes, protrusions, or a combination of same, for example.

In some embodiments, the projecting lengths of the projections 230 make the thickness or width of the respective leg 210 approximately double (e.g., measured along substantially parallel axes) when measured to include the projections 230. In some embodiments, this arrangement these can double a holding power, strength, and/or fastening effect of the staple 200. In some embodiments, the spacing or distance between the projections 230 can be selected to be based on the size, usage, and/or desired fastening strength of the staple 200. In some embodiments, the tip (e.g., an end that is not connected to the leg 210) of a projection 230 is sharp or smooth. In some embodiments, the configuration of the staple 200 can be changed, for example, the staple 200 can have three or four legs 210 and projections 230 such as barbs or anchors can be applied to all the legs 210. These projections 230 can be configured as described in relation to embodiments of staple 200 having two legs 210.

In some embodiments, the length of a projection 230 can be equal to the length of another projection 230. In some embodiments, the length of a projection 230 is different from the length of another projection 230. For example, the projections 230 can have different lengths based on the particular design and application.

Example dimensions of the staple 200 is a 2 inch by 0.5 inch 15.5 gauge staple. These dimensions may be suitable for sub-floor and hardwood flooring. Other example staple 200 dimensions include 1.2 inches, ¾ inches, and 1 inch staples 200, measured from a tip 240 to a joining member 220. Staples sizes can be designed and manufactured according to various applications. The tips 240a and 240b can be sharp or not sharp. In some embodiments, the tip is not sharp. For example, the tip can be tapered and end in a flat edge. In some embodiments, the tip is sharp. For example, the tip can be tapered and end in a point.

In some embodiments, a nail 100 or staple 200 is created using a mold based on the desired design of the nail 100 or staple 200. Where the nail 100 or staple 200 is comprised of metal, hot metal material is poured into the mold. The hot metal material is cooled, and the cooled material is removed from the mold and hammered and/or shaped to the desired shape, configuration, and design of the nail 100 or staple 200. For example, projections 130 or 230 can be formed in the mold and subsequently finished by hammering or shaping after removal from the mold or, alternatively, can be completely formed and finished in the mold depending on the mold design, manufacturing machinery, and desired application of the nail 100 or staple 200.

As an example, when manufacturing a nail 100, a mold is made, and metal or other suitable material is poured into the mold to form the kind of nail required. After the metal has been formed into a shape, then the formed metal or wire is cut and the head of the nail is hammered into shape. Various nail producing machinery can be used, and the production method can be based on the machine one uses.

In some embodiments, staple 200 is created from a wire, where projections 230 are formed by cutting into the wire at an angle such as about 60%. In some embodiments, staple 200 is manufactured by forming a wire having at least one projection extending at an angle from the wire by applying material to a cavity in a mold, removing at least one piece of material from the mold, the at least one piece of material being the wire, and shaping the wire to form the staple having one or more projections. For example, the staple can be a fastening device having a first leg; a second leg being substantially parallel to the first leg and connected to the first leg at a joining member arranged substantially orthogonal to the first leg and the second leg; and at least one projection connected to the first leg and extending from the first leg at an angle. In some embodiments, two or more pieces of material are removed from the mold and glued together to form the wire. The mold can have a cavity that is shaped to create a wire having upward projections such that the wire can be bent or shaped to form a staple 200.

In some embodiments, nails 100 are formed and produced in a mold, are taken out in a wire form, and the heads are hammered or molded depending on the machinery being used for making the particular type of nail 100.

A projection can be incorporated in the designing and making of nails 100 and staples 200. In some embodiments, with the projections, the nail's 100 shank or the staple's 200 legs will be enlarged to double the size, thus increasing the holding power of these devices (for example, by 100%) as a result of the projections having a better holding and securing power than just having a smooth shank or legs.

Nails 100 and staples 200 can be made by first making a mold. When designing the mold, the projections' shape and location should be taken into consideration. Material can then be poured into the mold. The material can be metal or another suitable material. In manufacturing nails 100, a machine can cut the length for the nail 100, hammer one end to form the head, and cut the other end to form the tip.

The manufacturing of staples 200 can be similar. For example, a mold can be created having the projections incorporated. A staple can comprise several molded wires that are glued together. The wire can then be bent and cut to the desired size.

As an example, when manufacturing a staple 200, the same molding concept is applied as for manufacturing a nail 100, except the staples 200 are produced by putting the designed wires together by glue or similar material then cutting the material into the required length and bending same to produce an upside-down U-shape.

Different metal treatments can be used in manufacturing the nail 100 or the staple 200 and can be selected based on the type of fastener. For example, nails 100 and staples 200 can be created with a rust protection coating for outdoor applications or can be heat treated.

Various example embodiments will now be described. There are provided fastening devices such as a nail and a staple each having at least one projection (such as a barb, anchor, spike), each of the projections extending upwardly from the body at an angle (e.g., 60 to 88 degrees) away from the bottom tip(s) of the device's body. For example, in the case of a nail, there can be two or more projections extending from the shank of the nail, each spaced at substantially equal distances apart. In the case of a staple, there can be at least one projection connected to the inside surface of a first leg of the staple, the first leg being substantially opposite to the inside surface of a second leg of the staple. The staple is in upside-down U-shape in some embodiments. The tip(s) of the nail or staple can be sharp or not sharp, depending on the device's application and size.

In some embodiments, these improved fastening devices substantially increase the holding power due to the projections enlarging the size of the shank or the legs to double and can secure a wood structure or products it fastens together. This can increase the durability, life, and safety of wood structures and products, including houses, roofs, decks, fences, furniture, and related items.

Further example fastening devices will now be described. There are provided two kinds of fastening devices, namely: (a) a nail; and (b) a staple, each having at least one similar type of improvement. For example, in some embodiments, a nail is a device comprising a substantially straight body having at least one projection each extending from the body at an upward angle, the degree of the angle being based on the application and the size of the nail. The combined dimension of the projection (e.g., barb) and body (e.g., shank) should be slightly less than the head of the nail. As another example, in some embodiments, a staple is an upside-down U-shaped body device that has a projection extending from the inside area at an angle, in some embodiments, one or more projections (e.g., barbs) can also be at the outside or exterior area or surface of the legs). The degree of the angle is based on the application and size of the staple. Although these embodiments can provide an increased fastening strength and holding power, the application of these fastening devices can be adapted for use with applicators such as hammers or air guns. The fastening devices can be applied manually or mechanically.

Example specifications of a nail 100 according to some embodiments will now be described. In some embodiments, the nail has sharp projections. In some embodiments, the nail has smooth projections. In some embodiments, the nail has a sharp tip. In some embodiments, the nail has a smooth tip. The upward angle of a projection can be around 70 degrees. The total combined diameter of the shank of the nail plus the projections can be slightly less than the nail head. The projections can start around 15% below the head, based on the total nail length, and be spaced apart along the length of the nail until around 7.5% above the bottom tip of the nail. The distance between each projection can be variable.

Example specifications of a staple 200 according to some embodiments will now be described. The projections of the staple can be at around a 70 degree upward angle. In one embodiment, the projections can be sharp. In another embodiment, the projections can be smooth. The size of the projection and the staple leg are in equal proportions. Projections can be placed, based on the total length of the leg (measured from the arch of the staple to the bottom of the staple) at about 15% below the arch and be spaced along the leg until around 7.5% above the leg tip. The legs tips are sharp but can be smooth according to some embodiments.

Embodiments described herein can be used for wood and other applicable construction projects, including according to building codes and practices of Canada and the rest of North America for building roofs, decks, walls, floors, and other structures.

Example applications of embodiments described herein will now be elaborated.

In Ontario, Canada, to build a two-story detached house with about 2500 square feet of living area, the roof can be built with 2×6 inch studs as rafter and joist, with 16 inch spacing over centre (o.c.), then covered with ⅝ inch thick plywood or oriented strand board (OSB) as sheathing, and then cover with tar paper and shingles on top. Similar wood-related specifications can be used for wall framing.

To build a deck for a house, where the deck is sized 10 feet (distance measured from the house) by 18 feet wide, the joists can be 2×10 inch treated lumber, installed at 16 inch o.c. as base. On top, the decking or flooring can be 2×6 inch treated wood with or without space in between. Nails 100 can be the primary fastening device used.

To build an indoor floor, 2×10 inch wood (e.g., untreated wood) can be used at 16 inch o.c. as joists and covered with ⅝ inch or ¾ inch thick plywood or OSB broad as sub-floor. Nails 100 and/or staples 200 can be the primary fastening devices used.

To build a frame for two-story house with about 2500 square feet of living space, the frame can be built with 2×6 inch studs at 16 inch o.c. The outside can be covered with ⅝ inch thick plywood or OSB broad.

The above woodwork specifications can be used for most residential construction projects. Bringing the wood together requires a fastener, such as a nail and/or staples.

For building a house, various fasteners can be used, for example, a 3 inch, No. 10d nail (with a 0.148 inch diameter) for joists, rafters, flooring, decking; and wall framing; a 1.25 inch no. 8d nail for roof or wall sheathing or shingles. The fasteners can be applied 16 inches o.c. or per manufacturer's specifications, by using an air gun or hammer.

However, materials such as wood can shrink after installation and can diminish the fastening effect of a nail or screw. Accordingly, a roof can be ripped off by strong winds, floors can develop a cracking sound or other noise such as when weight is applied to the floor, wood strips used in a deck may protrude or pop up, and frames can sag over time. These effects can develop due to the shrinkage of the material (e.g., wood) that can diminish the fastening strength of the nails or screws that were used with the material. Embodiments disclosed herein can mitigate or impede these effects. In some embodiments, a head 120 of a nail 100 is sized and dimensioned to be at least as large as an anticipated amount of shrinkage of the material to which it is applied at the location surrounding its elongated member 110. This can help the nail 100 have at least a threshold level of fastening effect. This level may be greater than or at least equal to the strength of a fastening effect of the nail 100 before the nail 100 is loosened or strained, for example, by strong winds, forces applied to the nail 100 or material to which it is applied, backward forces applied to the nail 100, shrinkage of the material to which the nail 100 is applied, or other disturbance.

In some embodiments, the design of a nail 100 or staple 200 allows compensation for wood shrinkage of a structure in which the nail 100 or staple 200 is used, thus making the structure solid and safe. After installation or construction of a wood structure using nails 100 or staples 200, in some cases, the wood will shrink to an extent. The nails 100, with anchoring hooks 130, maintain the fastening effect, in some embodiments. Similarly, where staples 200 having projections 230 are used in a structure, staples 200 maintain the fastening effect even where the structure material shrinks, in some embodiments.

In some embodiments, nails 100 or staples 200 provide stronger and safer houses, such as at roofs, frames, floors, fences, and decks when used in these structures. Nails 100 or staples 200 can be applied and installed by air gun, hammer, or in a means used for application of other nails or staples, for example, like those without projections 130 or 230. Nails 100 or staples 200 can be used more quickly and easily than screws. An applicator for a staple 200 can include a hand-held stapler or a pneumatic stapler.

In some embodiments as described herein, projections on a fastening device can increase the holding power of the fastening device.

In North America, the primary material for housing construction is wood and lumber. Whether building a roof, wall frame, floor, deck, fence, etc., the fastening device for holding the wood together are nails and perhaps in combination with staples. Nails can be as sized and dimensioned as shown in Table 1. These nails can be from 1 inch to 3.5 inches long, and each comprise a head (e.g., round shaped), shank (e.g., a smooth body), and a sharp tip at the bottom. Workers can apply the nails by hand (hammer) or air gun. When a nail is hammered into wood, it creates a holding power; when a worker hammers a nail into two pieces of wood, the effect is to hold the wood pieces together.

This holding power can be diminished. After time and unavoidably, most construction grade wood will shrink a little. As the wood around the shank area of a nail retreats, even shrinking by only a little bit, that can cause the nail's holding power to diminish. As a result, a floor built using the nail can have cracking noise, or when the weather is stormy, an entire roof built using the nail can be lifted and blown away.

The holding power of the nails can be enhanced and improved, for example, by 100%. As the wood for house and related construction inevitably will shrink, to make better and safer houses, the holding power of the fastener devices, mainly nails, and to some degree, staples, should be improved, especially as these two devices can be applied by hand or machinery, and quickly. For furniture, staples can be used for enhancing the structures' longevity.

The effect of incorporating projections (e.g., barbs, anchors, spikes) onto the nails' shank or the staple's legs, according to some embodiments, is to increase these devices' holding power, for example, by 100%.

In some embodiments, when manufacturing nails or staples, molds are designed and made. Barbs can be incorporated into the molds. The barbs are incorporated and become part of the nail's shank or the staple's legs, at an upward angle from 60 to 88 degree. The added barbs make the shank's diameter double. The size of the barbs and the shank can be equal. For example, a 3-inch nail has a shank 0.148 inches in diameter and a head 5/16 inches in diameter. The ratio of the sizes of the head to the shank is 2.11, meaning the head is 2.11 times bigger than the shank. Table 1 shows all this ratio is bigger than 2 in those examples.

The barbs can make the shank size double. By doubling the shank size and with a securing force provided by the barbs, the nails' holding power can be increased by 100%, in some embodiments.

For example, according to some embodiments, if the shank's size has enlarged to double, the holding power will increase accordingly. The larger the shank, the greater its holding power. The barbs-shank assembly can improve its restraining power and can secure the material it has fastened into position, thus enhancing the structure's durability and safety.

The sizes of nails shown in Table 1 can be used for general construction, including roofs, wall frames, floors, decks, fences, and drywalls. These structures rely on nails and, to some degree, staples, to fasten wood together. With barbs incorporated onto the nails and staples, the holding power can increase by 100%, in some embodiments.

For greater clarity, where used herein, “substantially” includes “equal” or “exactly” and “substantially equal”.

The discussion herein provides example embodiments of the technology. The technology is considered to include all possible combinations of the disclosed elements. Accordingly, if one embodiment comprises elements A, B, and C and a second embodiment comprises elements B and D, then embodiments of the technology are contemplated to also comprise elements A, B, C, and D, as well as other remaining combinations of A, B, C, or D, even if not explicitly disclosed.

Although embodiments have been described in detail, it should be understood that various changes, substitutions, and alterations can be made herein. Moreover, the scope of the present application is not intended to be limited to the particular embodiments of the process, machine, manufacture, composition of matter, means, methods and steps described in the specification.

As can be understood, the examples described herein and illustrated are intended to be exemplary only.

What is claimed is:

1. A fastening device, comprising a substantially straight elongated member, the elongated member extending from a head to a tip along a longitudinal axis and having at least one projection each extending from the elongated member at an upward angle away from the tip.

2. The fastening device of claim 1, the elongated member having two projections, each projection being on substantially opposite sides of the surface of the elongated member.

3. The fastening device of claim 1, the distance measured between a first projection tip of a first projection and a second projection tip of a second projection being a length up to the length of the head measured along a substantially identical axis.

4. The fastening device of claim 1, the angle being in a range from about 60 degrees to about 88 degrees.

5. The fastening device of claim 1, two or more projections extending from the elongated member each at a substantially equal distance from the head.

6. The fastening device of claim 1, two or more projections connected to the elongated member along an axis substantially orthogonal to the longitudinal axis, the two or more projections being spaced apart at substantially equal distances on the surface of the elongated member.

7. The fastening device of claim 1, at least one projection connected to the elongated member at a distance from the head equal to about 15% of the length of the elongated member measured from the head to the tip.

8. The fastening device of claim 1, two or more projections being spaced apart at substantially equal distances on the surface of the elongated member along the longitudinal axis.

9. The fastening device of claim 1, at least one projection connected to the elongated member at a distance from the tip equal to about 7.5% of the length of the elongated member measured from the head to the tip.

10. The fastening device of claim 1, the tip being not sharp.

11. The fastening device of claim 1, the width of the elongated member and the distance that one or more of the projections extend from the elongated member measured along substantially the same axis, being double the width of the elongated member measured along substantially the same axis.

12. A fastening device, comprising a first leg; a second leg being substantially parallel to the first leg and connected to the first leg at a joining member; and at least one projection connected to the first leg and extending from the first leg at an angle.

13. The fastening device of claim 12, at least one projection connected to an interior surface of the first leg, the interior surface being substantially opposite to an interior surface of the second leg.

14. The fastening device of claim 12, at least one projection connected to the first leg and extending upwardly at an angle away from a tip of the first leg.

15. The fastening device of claim 14, the angle being in a range from about 60 degrees to about 88 degrees.

16. The fastening device of claim 12, one or more projections being spaced apart at substantially equal distances on the interior surface of the first leg along the longitudinal axis, and one or more projections being spaced apart at substantially equal distances on the interior surface of the second leg along the longitudinal axis.

17. The fastening device of claim 12, one or more projections connected to the exterior surface of the first leg or the second leg.

18. The fastening device of claim 12, the tip being not sharp.

19. A method for forming a fastening device, comprising:
forming a body with at least one projection connected to the body and extending at an angle away from a tip of the body by applying material to a cavity in a mold and removing the material from the mold; and

20. A method for forming a staple, comprising:
forming a wire having at least one projection extending at an angle from the wire by applying material to a cavity in a mold;
removing at least one piece of material from the mold, the at least one piece of material being the wire;
and shaping the wire to form a fastening device having a first leg; a second leg being substantially parallel to the first leg and connected to the first leg at a joining member arranged substantially orthogonal to the first leg and the second leg; and at least one projection connected to the first leg and extending from the first leg at an angle.
